(19) United States
(12) Patent Application Publication
(10) Pub. No.: US 2009/0020135 A1
(43) Pub. Date: Jan. 22, 2009

(54) COMBINED CLEANER APPARATUS, SYSTEM, AND METHOD OF USE THEREOF

(76) Inventor: Darius J. Adams, Township of Washington, NJ (US)

Correspondence Address: SCHMEISER, OLSEN & WATTS, 22 CENTURY HILL DRIVE, SUITE 302, LATHAM, NY, 12110, US

(21) Appl. No.: 11/780,798

(22) Filed: Jul. 20, 2007

(51) Int. Cl. B08B 3/02; B05B 9/03

(52) U.S. Cl. 134/1; 134/198; 239/302

(57) ABSTRACT

The present invention relates to a combined cleaner apparatus, a combined cleaner method, and a cleaner system. The combined cleaner apparatus includes a housing element, said housing element having a first housing element portion; a material sprayer and a material dispenser, wherein the material sprayer and the material dispenser are communicably associated to said first housing element portion; at least one material providing body, wherein the at least one of the material sprayer and the material dispenser is in communication with the at least one material providing body.

### BACKGROUND OF THE INVENTION

1. Technical Field

The present invention relates to an apparatus, system, and method of cleaning an object or tool. More specifically, the present invention pertains to a combined cleaner apparatus structured to clean medical tools and clean users of the medical tools.

2. Related Art

Because cleanliness and prevention of disease spreading is imperative in modern day society, it is important to allow the option of effectively and efficiently cleaning objects, including medical tools, instruments, users of those instruments, and hands of individuals. Accordingly, devices, systems, and methods have been provided to clean medical tools, users, and objects in the medical field. However, typical cleaning devices, systems and methods do not provide for the secure, reliable, efficient, and effective cleansing of both a user and medical tools or instruments. Hence, a need exists to provide a combined cleaner apparatus, system, and method thereof, which, inter alia, cleanses both users and tools in order to prevent and/or reduce the spread of disease, sickness, illness, and promote sterile, hygienic, sanitary, and clean environments.

### SUMMARY OF THE INVENTION

A first aspect of the present invention provides a cleaner apparatus, comprising: a casing; a material sprayer, movably engaged to said casing; a first casing portion of said casing; a material dispenser coupled to said first casing portion; and a material retaining member, said member removably attached to said casing, said material retaining member removably attached to said material sprayer and said material dispenser.

A second aspect of the present invention provides an integral cleaner apparatus, comprising: an integral casing; a material sprayer and a material dispenser, wherein a substantial portion of each of the material sprayer and the material dispenser are encased in said integral casing; and at least one container, a portion of said container is encased by said integral casing wherein each of the material dispenser and the material sprayer is configured to associate to said container.

A third aspect of the present invention provides A combined cleaner method, comprising the steps of: providing a combined tool and object cleaner apparatus, said combined apparatus including: a housing element, said housing element having a first housing element portion; a material sprayer and a material dispenser, wherein the material sprayer and the material dispenser are fixedly associated to said first housing element portion; at least one material providing body, wherein the at least one of the material sprayer and the material dispenser is in communication with the at least one material providing body; a cleansing material, said cleansing material retained in said material providing body; positioning at least a portion of an object in operable proximity with said first housing element portion; and triggering at least one of said material dispenser and said material sprayer at least one time to expend the cleansing material onto at least a portion of said object.

A fourth aspect of the present invention provides a cleaner system, comprising: a plurality of cleaner apparatus', wherein each cleaner apparatus includes: a casing; a material sprayer, movably engaged to said casing; a first casing portion of said casing; a material dispenser coupled to said first casing portion; a material retaining member, said material retaining member housed in said casing, said material retaining member coupled to at least one of said material sprayer and said material dispenser; a remote material source; a cleansing material, said cleansing material retained in said remote material source; and at least one material supply tube for the plurality of cleaner apparatus', configured to associate each cleaner apparatus to the remote material source.

### BRIEF DESCRIPTION OF THE DRAWINGS

The present invention is described in detail below with reference to the drawings in which:

FIG. 1 shows a cut-away side view of an embodiment of a cleaner apparatus of the present invention;

FIG. 2 shows a front plan view of one embodiment of a cleaner apparatus of the present invention;

FIG. 3 shows a cut-away side view of another embodiment of a cleaner apparatus of the present invention;

FIG. 4 shows a perspective side view of an embodiment of a cleaner apparatus of the present invention;

FIG. 5 shows a partial cut-away perspective side view of an embodiment of a cleaner apparatus of the present invention;

FIG. 6 shows a side plan view of an embodiment of a cleaner apparatus of the present invention;

FIG. 7 shows a perspective side view of an embodiment of an integral cleaner apparatus of the present invention;

FIG. 8 shows a perspective side view of another embodiment of an integral cleaner apparatus of the present invention;

FIG. 9 shows a partial cut-away perspective side view of still another an embodiment of an integral cleaner apparatus of the present invention;

FIG. 10 shows an embodiment of a cleaner system of the present invention;

FIG. 11 shows another embodiment of a cleaner system of the present invention;

FIG. 12 shows a flow chart depicting a combined cleaner method embodiment of the present invention;

FIG. 13 shows a flow chart depicting another combined cleaner method embodiment of the present invention;

FIG. 14 shows a flow chart depicting a further combined cleaner method embodiment of the present invention; and

FIG. 15 shows a flow chart depicting a still further combined cleaner method embodiment of the present invention.

### DETAILED DESCRIPTION OF THE INVENTION

The present invention provides a cleaner apparatus, an integral cleaner apparatus, a cleaner system, and a combined cleaner method for cleaning objects, users, medical tools and devices. The present invention will be described in association with references to drawings; however, various implementations of the present invention will be apparent to those skilled in the art.

An object, as referred to herein, may include, for example, one or more of: a medical tool, a medical instrument, a tool, a writing implement, a writing aid, a reading aid, an article of clothing, an accessory, or a body part of a user, including one or more of the user's hands, arms, skin, or any other element, component, member, or part that a user may find need to cleanse, sanitize, decontaminate, or sterilize.

In the following paragraphs detailing the various embodiments of the present invention, one common theme is presence of both a material sprayer and a material dispenser in the variously described embodiments. The combined cleaner apparatus, as further described infra may give a user of the apparatus the option of using one, or both of the material sprayer and material dispenser in order to clean, sanitize, sterilize, decontaminate, and/or disinfect one or more objects. As such, a user may cleanse, sanitize, sterilize, decontaminate, and/or disinfect one or more objects at the same time.

The material sprayer and the material dispenser may have varying nozzles. That is, the material sprayer or material sprayer nozzle may be configured such that when cleansing material may be sprayed, or otherwise ejected, therefrom, the cleansing material may be pressurized in a greater or lesser degree than the cleansing material dispensed from the material dispenser.

The material sprayer or material sprayer nozzle may be configured such that the cleansing material exits the nozzle in a manner which may disperse in a wider surface area than the dispensed cleansing material from the material dispenser. In such a manner, the material sprayer may spray a predetermined thickness of cleansing material over a certain predetermined surface area, which may be proportionally affected by varying the displacement between the spray nozzle and the object target. In doing so, the material sprayer may disperse a spritz, spray, mist, aerosol, or atomized quantity of cleansing material onto an object. Once a thin layer of cleansing material is over the surface of the object, there will be a substantially diminished need for a user to touch the surface of the object in order to facilitate cleansing material surface area or even coverage over the object. Therefore, by spraying an object with the material sprayer, the cleansing material may cover a larger surface area than with, for example, a dispersion from the material dispenser. As such, the large surface area thinly layered with cleansing material may dry in a quick and more efficient manner in the object's ambient environment without aid form any outside factors or forces.

Contrastingly, the material dispenser or material dispenser nozzle may be configured, for example, such that a cleansing material quantity may be expelled in a spurt, one or more large droplets, a glob, or an otherwise finite control volume. In such a manner, a user or user operation or activity may be needed to further disperse the cleansing material after its initial expulsion from the material dispenser or material dispenser nozzle. As such, the initial expulsion of cleansing material from the material dispenser or material dispenser nozzle may be in a higher concentration than a mist or spray that may be produced by the material sprayer or material sprayer nozzle. That is, a user may operate one or both of the material sprayer and material dispenser with such desirable configurations in order to vary the treated surface area of one or more objects and/or the cleansing material volume that may be deposited thereon.

In other variations of the disclosed embodiments, discussed infra, the material sprayer may be configured to movably engage to an embodiment of the cleaner apparatus. As such, the material sprayer may be attached or rested in or on the apparatus, detached therefrom, posed or associated in a preferable proximity to one or more objects, and sprayed in order to expel cleansing material onto the surface of an object. It should also be noted that the material sprayer may be configured to remain in an extended position away from the apparatus while in operation, as the material sprayer may communicate to the apparatus via a retractable tubing. With, for example the tubing and attachable/detachable aspects of this embodiment, the material sprayer may be adjustable to work in many varying situations and conditions. That is, the material sprayer may be used on an object which may not sit or easily adjust to sit in the operable proximity of the material dispenser. Also, the material sprayer may be posed and reposed in rapid frequencies in order to facilitate quick positioning, repositioning, and spraying of varying angles of one object, many objects resting on a common surface, or a large object. In such a manner, it may be easier for a user to move or reposition a material sprayer about one or more objects than move and or reposition the objects.

Additionally, given the configuration of the varying embodiments of the apparatus, the apparatus may be installed and maintained as a plurality of stand alone units or units configured to a remote cleansing material source. As such, a plurality of users may have access to the apparatus and the benefits that it provides without long wait times or traveling to distances far from the user's current location.

An example of an embodiment of a cleaner apparatus 10 may comprise: a casing 20; a material sprayer 30, which may be movably engaged to said casing 20; a first casing portion 22 of said casing 20; a material dispenser 40 which may be coupled to said first casing portion 22; a material retaining member 50, said member 50 which may be removably attached to said casing 20, said material retaining member 50 may be removably attached to said material sprayer 30 and said material dispenser 40. Further, an embodiment of a cleaner apparatus 10 may comprise a cleansing material 52, wherein said cleansing material 52 may be retained in said material retaining member 50.

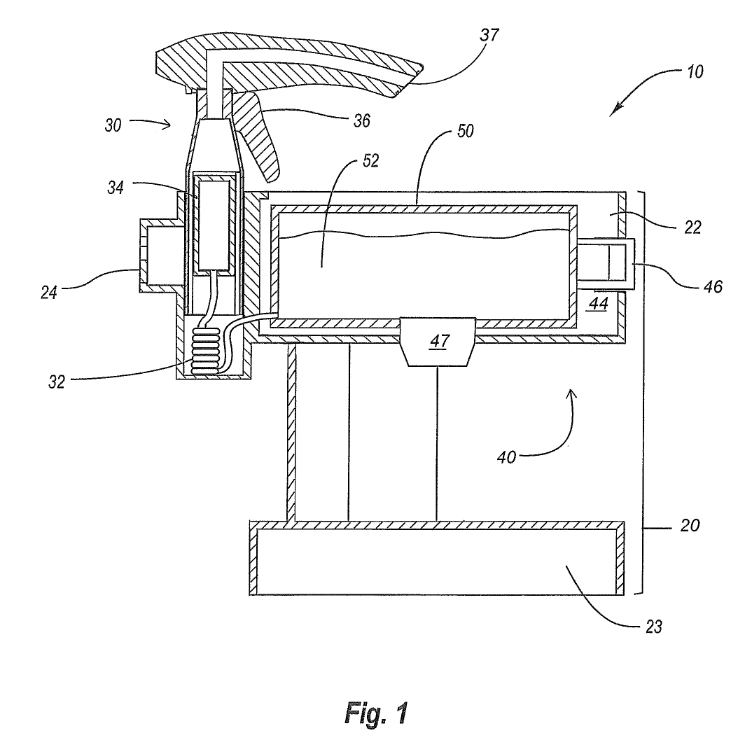

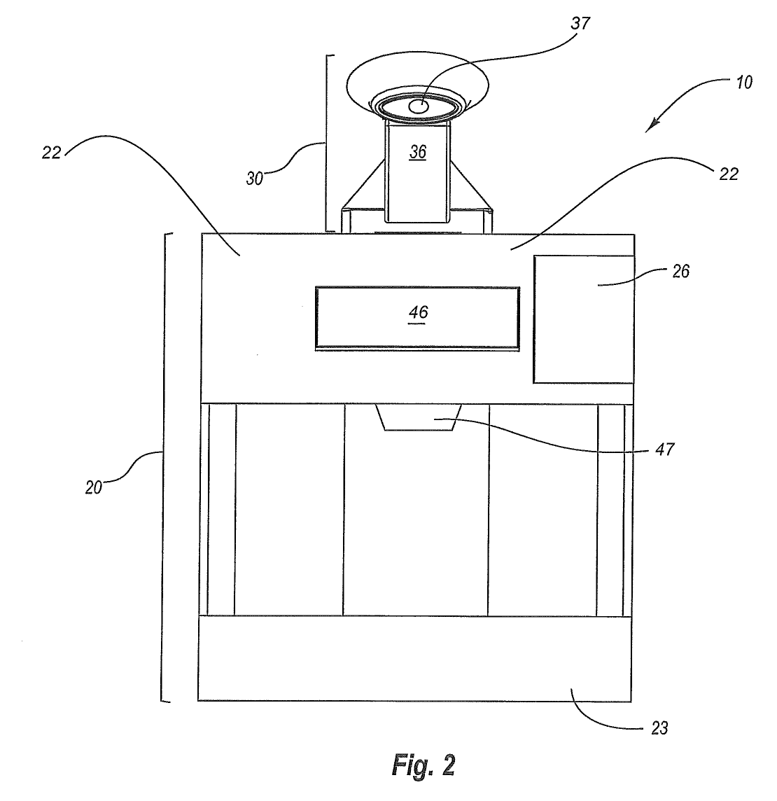

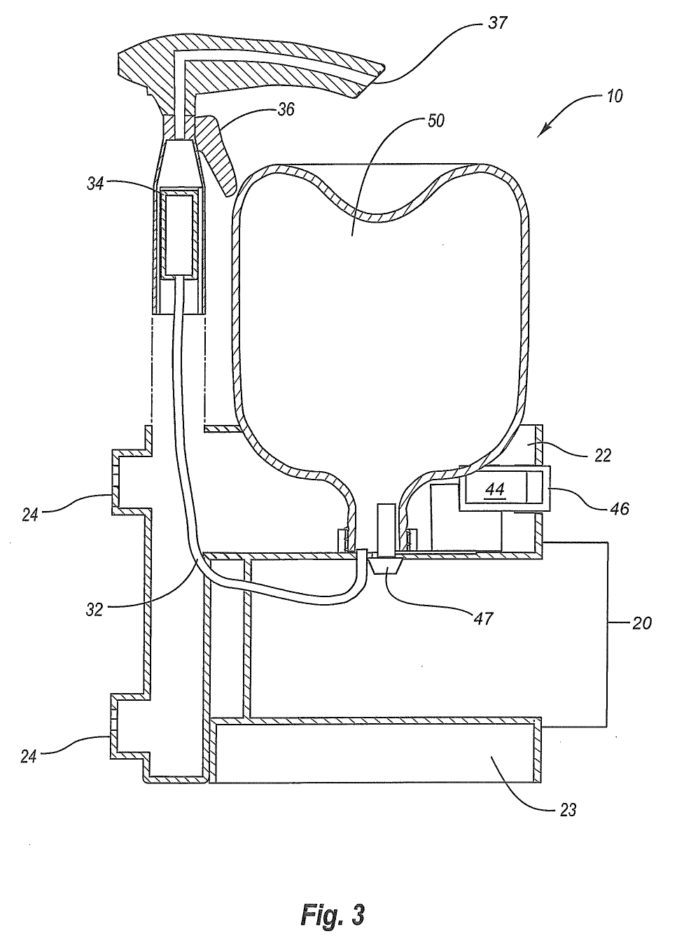

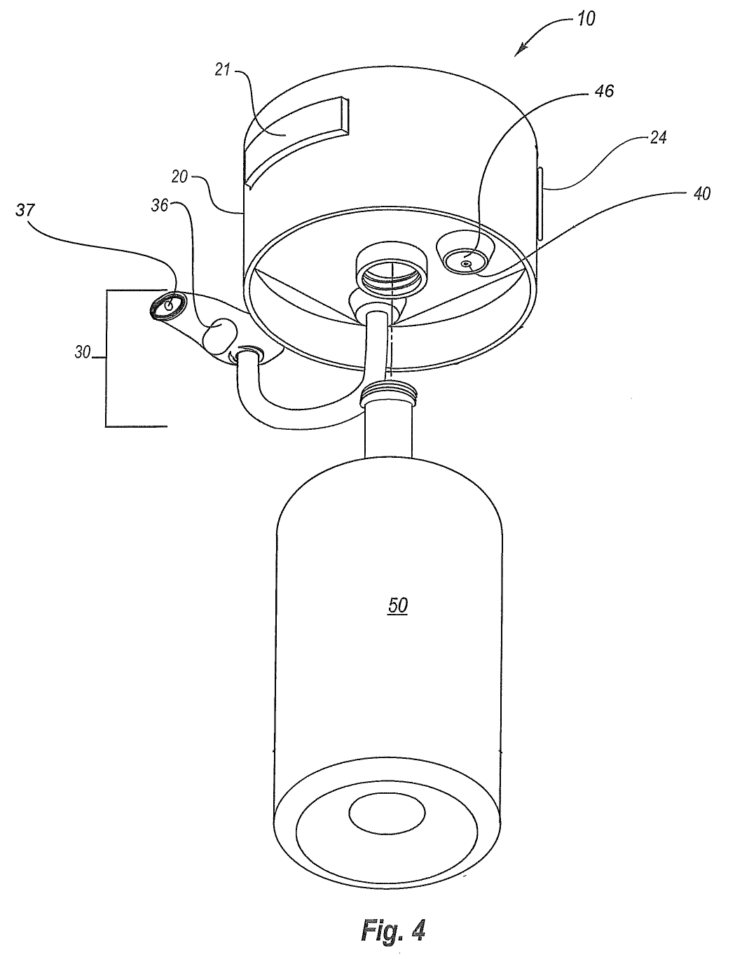

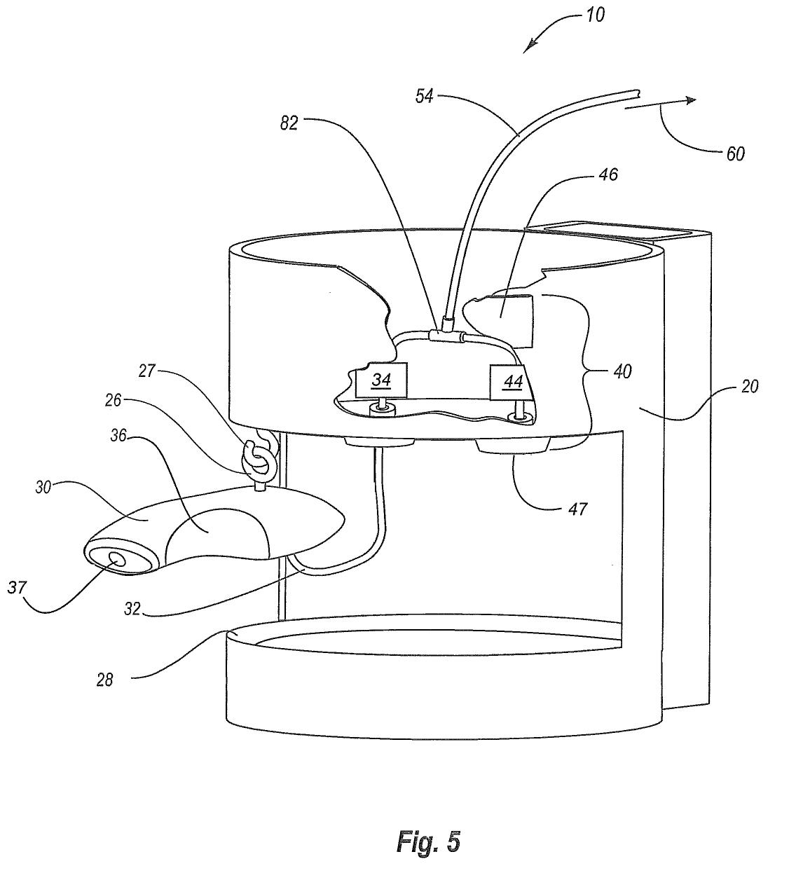

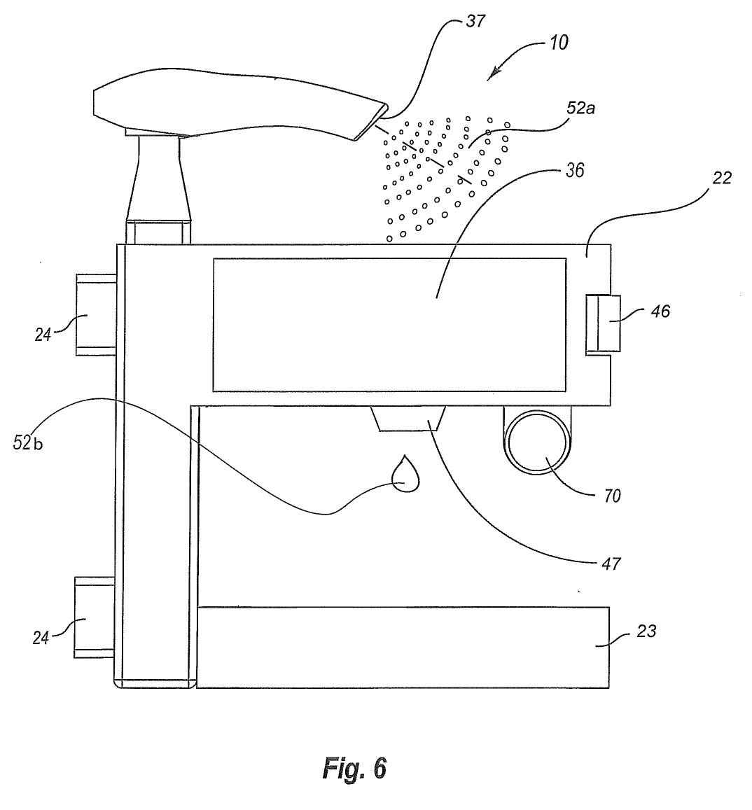

The cleaner apparatus may be variously embodied, for example, in FIG. 1, FIG. 2, FIG. 3, FIG. 4, FIG. 5, or FIG. 6. As shown, the embodiments of the cleaner apparatus 10 may comprise, for example: a casing 20; a material sprayer 30; a material dispenser 40; and a material retaining member 50. The various components will be discussed further below.

The casing 20 may be one integral component, as for example, the casing 20 in FIG. 3, FIG. 4, or FIG. 5. Alternatively, the casing 20 may comprise a first casing portion 22 and a second casing portion 23. This may be shown, for example, in FIG. 1, FIG. 2, or FIG. 6. The casing 20, the first casing portion 22, and the second casing portion 23 may be composed of, for example but not limited to: plastic, polymer, vinyl, ceramic, glass, fabric, cardboard, metal, wood, woven materials, and combinations thereof. The casing 20 may be opaque, translucent, transparent, or a combination thereof. Further, the casing 20 may be configured to allow the cleaner apparatus 10 to be mounted to a surface. The casing 20 may be constructed in any shape and may exist in varying sizes or dimensions.

As previously mentioned, the casing 20 may comprise a first casing portion 22 and a second casing portion 23. The first casing portion 22 of said casing 20 may, for example, substantially encase at least a portion of one or more of the elements of the cleaner apparatus 10. The second casing portion 23 may be configured to accept and retain an expended cleaning material 52 from said cleaner apparatus 10. That is, the second casing portion 23 may be configured with a lip 28 around the outer edge of the second casing portion 23 so that expended cleansing material 52 does not leak, drip, or drain onto a floor or other surface. The lip 28 may be shown, for example, in FIG. 5.

As an additional or alternative mechanism, the cleaner apparatus 10 may comprise a light source. The light source may aid a user in viewing the objects and materials that are currently being cleaned. For example, the light source may be an ultraviolet light source (hereinafter UV light) 70, as shown and illustrated in FIG. 6. That is, the cleaner apparatus 10 may further comprise a UV light 70. Also, the UV light 70 may be configured to possibly associate with, for example, the casing 20. With illumination from the UV light 70, objects may be sanitized by the ultraviolet illumination therefrom. That is, UV light 70 may be an effective germicidal component. As shown in FIG. 6, the UV light 70 may be configured to associate with the casing 20. It should also be noted that the UV light 70 may be associated with any portion of the casing 20, or alternatively, the first casing portion 22 or second casing portion 23 of an embodiment of the cleaner apparatus 10. The UV light 70 may be possible, or otherwise movably oriented, so that the incident angle of radiation may be changed by a user in order, for example, to accommodate objects and materials of varying size and nature. Also, the UV light 70 may either remain on or may be turned on subsequent to the spraying or dispensing of cleansing material 52 by the cleaner apparatus 10 so as to more effectively dry the expended cleaning material 52. The UV light 70 may be turned on and off in the same nature as the material dispenser 40 and/or the material sprayer 30. As such, the UV light 70 may be used solely or in combination with either the material sprayer 30 or the material dispenser 40.

The second casing portion 23 may also be equipped with one or more other features (not shown), including, for example, a ventilation member such as a fan or air blower and/or a drain into an expended material container so that the expended cleansing material 52 that may accumulate on the second casing portion 23 may be dried or otherwise evacuated.

The casing 20 may also comprise a surface mounter 24 as shown in FIG. 1, FIG. 3, FIG. 4, and FIG. 6. For example, the surface mounter 24 may be integral to the casing 20, as shown in FIG. 3. As another example, the surface mounter 24 may be removably attached, coupled, or otherwise attached to the casing 20. This is shown, for example, in FIG. 1 and FIG. 6. The surface mounter 24 may be used to mount the cleaning device 10 to a surface, including walls, doors, floors, or tabletops. The surface mounter 24 may be configured to allow the cleaner apparatus 10 to be screwed, nailed, hooked, locked, glued, buttoned, snapped, affixed, combinations thereof, or otherwise attached to the surface. The surface mounter 24 may be located, for example, on the first casing portion 22, the second casing portion 23, or both portions of the casing 20.

The casing 20 may also be operatively configured to cooperate with a material sprayer 30 such that, for example, the material sprayer 30 may be movably engaged to said casing 20. In this manner, the material sprayer 30 may be accepted into at least a portion of the casing 20. That is, the material sprayer 30 may be accepted into, as examples, the first casing portion 22 or the second casing portion 23 of the casing 20.

There are several potential configurations to movably engage the material sprayer 30 with the casing 20. For example, the material sprayer 30 or the casing 20 portion may be configured to allow the material sprayer 30 to substantially fit and sit onto the casing 20. Alternatively, the material sprayer 30 may remain anchored with the aid of its fit onto the casing 20, may be located by gravity, or may utilize one or more other anchors. This may be shown, for example, in FIG. 1, FIG. 3 or FIG. 6. As another example, the retractable tubing 32 of the material sprayer 30 may operate to retract the material sprayer 30 to a removably engaged position with the casing 20. That is, the retractable tubing 32 itself may be flexible or stretchable beyond its resting position as may be shown, for example, in FIG. 1 or FIG. 3. In effect, the retractable tubing 32 may be wound, folded, looped, or otherwise stored in a storage position inside the casing 20. Additionally, the retractable tubing 32 may be longer, shorter, wider, or thinner than it is depicted in FIG. 1 and FIG. 3, as the drawings are for illustrative purposes only.

The material sprayer 30 may, in addition, be latched, hooked, snapped, magnetically associated, or otherwise removably engaged to the casing 20. For example, as shown in FIG. 5, the material sprayer 30 comprises a hook 26 that may be hooked onto attaching member 27. The attaching member 27 may be located, for example, on the first casing portion 22.

The material sprayer 30 may be comprised of a spray pump mechanism 34 and a spray initiator 36. Further, the cleansing material 52 may exit the material sprayer 30 through the material sprayer nozzle 37, as shown in FIG. 1, FIG. 2, FIG. 3, FIG. 4, FIG. 5, and FIG. 6. The spray pump mechanism 34 may be, for example, a manual pump or an automated pump which may be initiated by the spray initiator 36 of the material sprayer 30. Activating the spray initiator 36, may comprise operating a lever, a switch, a button, or electronic mechanism.

The spray initiator 36 may be, for example, a trigger or lever. The trigger or lever spray initiator 36 may be pulled in order to operate the spray pump mechanism 34. This may be shown, for example, in FIG. 1 and FIG. 3. Upon activation of the spray initiator 36, the material sprayer 30 may expel a spray as previously discussed.

As still another example, the spray initiator 36 may be, for example, a button. The button spray initiator 36 may be pushed in order to operate the spray pump mechanism 34. This may be shown, for example, in FIG. 5. Upon activation of the spray initiator 36, the material sprayer 30 may expel a spray as previously discussed.

As still another example, in order to activate the spray pump mechanism 34, the spray initiator 36 may be an electronic mechanism. For example, the spray initiator 36 may be a key pad, a lock, an electronic key card station, a biometric data scanner, or a voice, motion, or pressure operated sensor. To initiate operating the spray pump mechanism 34, the user may, for example, enter the correct pin number into a key pad, unlock a lock, swipe an electronic key card, offer a biometric data sample, or activate a voice, motion, or pressure sensor. For example, FIG. 4 illustrates the case in which the spray initiator 36 is a sensor. The sensor of FIG. 4 may be, for example, either a motion sensor or a pressure sensor. As an additional example, FIG. 6 may illustrate the case in which the spray initiator 36 is an electronic device, including, for example, a touchpad with numbers or letters, a voice sensor, a fingerprint or retinal scanner (biometric data collecting device), or an electronic card reader swiping mechanism.

It is also inherently included herein that combinations of one or more of the spray initiating activities previously mentioned may be incorporated as the spray initiator 36. It should be noted that any of the aforementioned mechanisms that may prove difficult for the user to both operate the spray initiator and hold an object or material to be cleaned may be set up to operate on a timer such that the user may be given an appropriate time to activate the spray initiator 36 and aim the material sprayer 30 at an object or material.

Once initiated, the spray pump mechanism 34 may bring cleansing material 52 from the material retaining member 50 to the material sprayer 30 to be expelled from the cleaner apparatus. The spray of cleansing material 52 that may be sprayed from the material sprayer 30 may be, for example, a liquid jet, a mist, an atomized spray, an aerosol spray, or a nebulized spray.

The material sprayer 30 may be operatively associated with the material retaining member 50 such that the material sprayer 30 may communicate directly with the material retaining member 50. This may be shown, for example, in FIG. 4. Or, the spray pump mechanism 34 of the material sprayer 30 may communicate with the material retaining member 50 by a retractable tubing 32. This may be shown, for example, in FIG. 1, FIG. 3, and FIG. 5. The retractable tubing 32 may be configured to operably couple said material sprayer 30 to said material retaining member 50. With one end of the retractable tubing 32 attached to the material retaining member 50 and another end of the retractable tubing 32 attached the material sprayer 30, the retractable tubing 32 may communicate the cleansing material 52 to the material sprayer 30 with the pressure differential that may be created by a spray pump mechanism 34.

The retractable tubing 32 may be composed of, for example, plastic, polymer, PVC, glass, metal, ceramic, polytetrafluoroethylene (PTFE), or any other material known and used in the arts to transport materials from source to destination. Referring again to FIG. 1, at least a portion of the retractable tubing 32 may be substantially enclosed by the first casing portion 22 of the casing 20 when, for example, the material sprayer 30 may be engaged to the casing 20. Alternatively, at least a portion of the retractable tubing 32 may be substantially enclosed by the lower oriented first casing portion 22 of the casing 20 when, for example, the material sprayer 30 may be engaged to the casing 20.

In addition to the material sprayer 30, a material dispenser 40 may also be associated with the casing 20 of the cleaner apparatus 10. Alternatively, the material dispenser 40 may be coupled to the first casing portion 22 of the casing 20. The material dispenser 40 may be housed either partially or completely within the first casing portion 22. As shown in FIG. 4, FIG. 5, and FIG. 6, the material dispenser 40 may further comprise a dispense pump mechanism 44 and a dispense initiator 46. The dispense pump mechanism 44 may be, for example, and automated or manual pump. The dispense initiator 46 may be, for example, a trigger. Upon activation of the dispense initiator 46, the material dispenser 40 may dispense a portion of cleansing material 52. Further, the cleansing material 52 may exit the material dispenser 40 through the material dispenser nozzle 47, as shown in FIG. 1, FIG. 2, FIG. 3, FIG. 4, FIG. 5, and FIG. 6.

In order to activate the dispense initiator 46, a user may operate a lever, a switch, or a button. As is shown in FIG. 1, FIG. 2, and FIG. 3, the user may push a dispense initiator 46 button. As another example, in order to activate the dispense initiator 46, a user may enter the correct pin number into a key pad, unlock a lock, swipe an electronic key card, offer a biometric data sample for reading by a biometric data collector, activate a voice activated sensor, move to activate a motion sensor, or stand or push on an area to activate a pressure activated sensor. As is shown in FIG. 4 and FIG. 5, the dispense initiator 46 may be a motion sensor or a pressure sensor. Also, after a certain time, a timer automated sensor may activate the dispense initiator 46.

It is also noted herein that combinations of those dispense initiating activities previously mentioned may be included herein. Once the dispense initiator 46 has been activated, the cleansing material 52 may be dispensed from the material dispenser 40 with the aid of the dispense pump 44. The dispense pump may be a manual pump, as when a user pushes a manual button in, or the dispense pump 44 may be an automated pump, as may be activated when a user trips a motion or pressure sensor.

The casing 20 may also incorporate a material retaining member 50, wherein the material retaining member 50 may be removably attached to said casing 20. The material retaining member 50 may be, for example, a container, a remote feed tube 54 with a remote material source 60 as shown in FIG. 5, or a combination of both. The material retaining member 50 as a container may be removably attached, as by being inserted, for example, into the casing 20 such that the entire container is enclosed and may be secured therein. This may be shown, for example, in FIG. 1. Also, the material retaining member 50 may be removably attached by being only partially inserted such that at least a portion of the container extends beyond the casing 20. This may be shown, for example, in FIG. 3 or FIG. 4. Further, if the material retaining member 50 is a remote feed tube 54 and remote material source 60, the remote feed tube 54 may be fed into any location of the casing 20, such that a portion of the remote feed tube is enclosed in the casing 20. This may be shown, for example, in FIG. 5.

The material retaining member 50 may be removably attached to the material sprayer 30 and the material dispenser 40. That is, the material retaining member 50 may be inserted into the top, bottom, or side portion of the casing 20. This may be shown, for example, in FIG. 1, FIG. 3, FIG. 4, or FIG. 5. The material retaining member 50 may be of any shape, dimension, or material that may retain a cleansing material 52. For example, the material retaining member 50 may comprise at least one container, canister, bottle, or bag, configured to associate with said casing 20. Or, the material retaining member 50 may comprise at least one remote feed tube 54 or pipe configured to couple a material source 60 to said cleaner apparatus 10. This may be shown, for example, in FIG. 5. The material retaining member 50 may, for example, have at least one rigid wall. Alternatively, the material retaining member 50 may, for example, have at least one flexible wall such that as material is dispensed from the material retaining member 50, the volume of the container likewise proportionally decreases. That is, the cleansing material 52 may be retained in, for example, the material retaining member 50 until a time in which the spray initiator 36, the dispense initiator 46, or both may be activated. FIG. 5 shows the dispense initiator 46 and the spray initiator 36 in communication with the material dispenser 40 and material sprayer 30, respectively. The material retaining member 50 may be composed of, for example, plastic, vinyl, polymer, wood, metal, nylon, glass, fabric, or combinations thereof, to facilitate the retention of the cleansing material 52.

The cleansing material 52 may come out of the material dispenser 40 in a liquid jet, a spurt, a squirt, a shot, an encapsulated portion, a burst, a liquid spray, or a dense mist. Further, the cleansing material may be expelled from the material dispenser 40 as a low viscosity liquid, a high viscosity liquid, or plurality of small droplets of liquid.

The cleansing material 52 may be composed of one or more of various materials within the cleaning, sterilizing, sanitizing, disinfecting, or decontaminating fields. Also, the cleansing material 52 may be a liquid of high or low viscosity. For example, the cleansing material 52 may be composed of one or more materials selected from the group consisting essentially of: alcohol, phenol, peracetic acid, hydrogen peroxide, chlorine compounds, iodophors (iodine complexed with solubizing agent), peroxygen compounds, quaternary ammonium compounds, and combinations thereof. Further, the cleansing material 52 may be a known sterilizing agent, germicide, anti-microbial agent, disinfectant, cleanser, any OSHA approved material for cleaning, decontaminating, disinfecting, or sterilizing, or combinations thereof.

In operation, the cleansing material 52 may exit the material sprayer 30, the material dispenser 40, or both at the same time. Upon the cleansing material's 52 exiting, as previously mentioned, the casing 20 may further comprise a second casing portion 23. This second casing portion 23 may be configured to associate with the material dispenser 40 so that the second casing portion 23 may catch any expended cleansing material 52 with, for example, a lip 28 as is shown in FIG. 5.

The cleaner apparatus 10 may include a relevant information indicator 21, as shown in FIG. 4, which may adhere, attach, affix, or associate to at least a portion of the casing 20. The relevant information indicator 21 may provide written or pictorial instructions to a user, material safety data sheet information about the cleansing material 52 contained in and expelled therefrom, manufacturer contact information, et cetera, to aid and/or inform the user in operating the apparatus 10.

A further embodiment may comprise integral cleaner apparatus 11. The integral cleaner apparatus 11 may include, for example: an integral casing 25; a material sprayer 30 and a material dispenser 40, wherein a substantial portion of each of the material sprayer 30 and the material dispenser 40 are encased in said integral casing 25; and at least one container 51, a portion of said container 51 is encased by said integral casing 25; wherein each of the material dispenser 40 and the material sprayer 30 is configured to associate with said container 51 and configured to transmit cleansing material 52 from said container 51 onto an object.

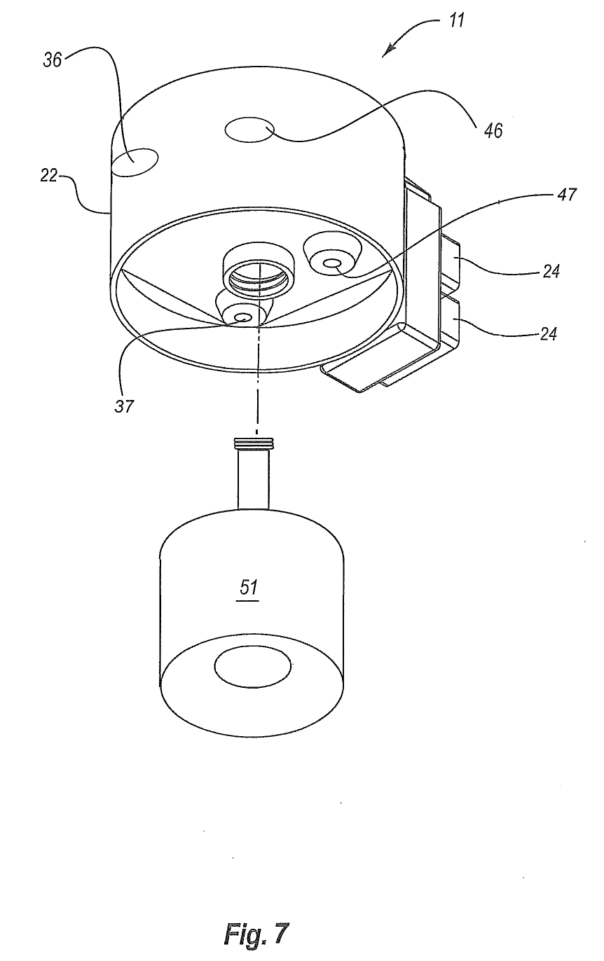

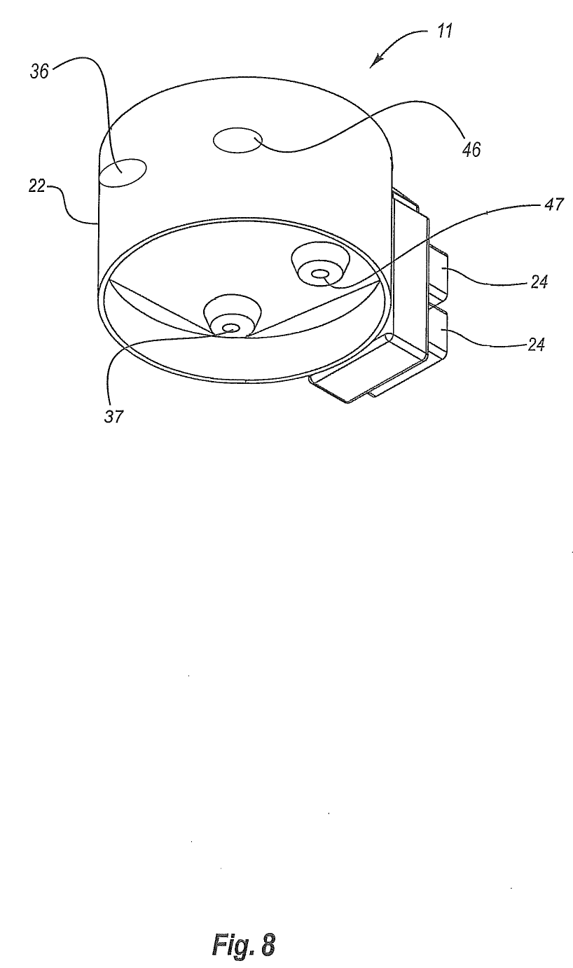

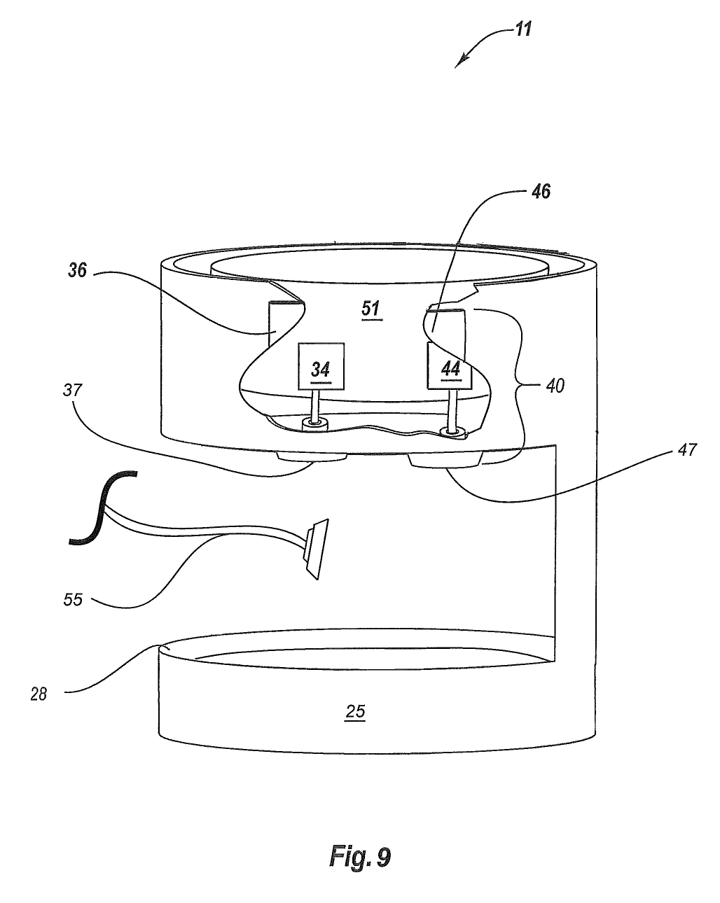

Embodiments of an integral cleaner apparatus 11 are shown, for example, in FIG. 7, FIG. 8, and FIG. 9. It should be noted that in reference to embodiments of the integral cleaner apparatus 11, the discussion of reference numbers herein that may also be common to FIG. 1 through FIG. 6 may refer to the parts, as depicted, in FIG. 7 through FIG. 9, and likewise utilized in one or more embodiments of the integral cleaning apparatus 11. As shown, the integral cleaner apparatus 11 may comprise, for example: an integral casing 25; a material sprayer 30; a material dispenser 40; a container 51; and a cleansing material 52. The various components will be discussed further below.

The integral casing 25 may be one integral component or alternatively more than one component that is constructed to configure a single, integral casing in use. The integral casing may be depicted, for example, in FIG. 7, FIG. 8, and FIG. 9. The integral casing 25 may be composed of, for example, but not limited to: plastic, polymer, vinyl, ceramic, glass, fabric, cardboard, metal, wood, woven materials, and combinations thereof. The integral casing 25 may be opaque, translucent, transparent, or a combination thereof. Further, the integral casing 25 may be configured to allow the integral cleaner apparatus 11 to be mounted to a surface. It should be noted that the integral casing 25 may be constructed in any shape and may exist in varying sizes or dimensions.

The integral casing 25 may, for example, substantially encase at least a portion of each of the material sprayer 30 and the material dispenser 40. The integral casing 25 may be configured to accept and retain an expended cleaning material 52 from said integral cleaner apparatus 11. That is, the integral casing 25 may be configured with a lip 28 around the outer edge of the integral casing 25 which may extend beneath the integral casing 25 so that expended cleansing material 52 does not leak, drip, or drain onto a floor or other surface. The lip 28 may be shown, for example, in FIG. 9.

As an additional or alternative mechanism, the integral cleaner apparatus 11 may comprise a light source. The light source may aid a user in viewing the objects and materials that are currently being cleaned. For example, the light source may be an ultraviolet light source (hereinafter UV light) 70 (as shown and illustrated in FIG. 6). That is, the integral cleaner apparatus 11 may further comprise a UV light 70. Also, the UV light 70 may be configured to possibly associate to, for example, the integral casing 25. With illumination from the UV light 70, objects may be sanitized by the ultraviolet illumination therefrom. UV light illuminating onto the surface of an object may be an effective germicidal component. The UV light 70 may be configured to associate with the casing 20. It should also be noted that the UV light 70 may be associated with any portion of the integral casing 25 or the integral cleaner apparatus 11. The UV light 70 may be possible, or otherwise movably oriented, so that the incident angle of radiation may be changed by a user in order, for example, to accommodate objects and materials of varying size and nature. Also, the UV light 70 may either remain on or may be turned on prior, during, or subsequent to the spraying or dispensing of cleansing material 52 by the integral cleaner apparatus 11 so as to more effectively dry the expended cleaning material 52. The UV light 70 may be turned on and off in the same nature as the material dispenser 40 and/or the material sprayer 30. As such, the UV light 70 may be used solely or in combination with either the material sprayer 30 or the material dispenser 40.

The integral casing 25 may also be equipped with one or more other features (not shown), including, for example, a ventilation member such as a fan or air blower and/or a drain into an expended material container so that the expended cleansing material 52 that is on the integral casing 25 may be dried or otherwise evacuated.

The integral casing 25 may also comprise a surface mounter 24 as shown in FIG. 7 and FIG. 8. The surface mounter 24 may be integral to the integral casing 25, or alternatively, the surface mounter 24 may be removably attached or removably coupled to the integral casing 25. The surface mounter 24 may be used to mount the integral cleaning apparatus 11 to a surface, including walls, doors, floors, or tabletops. The surface mounter 24 may be configured to allow the integral cleaner apparatus 11 to be screwed, nailed, hooked, locked, glued, buttoned, snapped, affixed, combinations thereof, or otherwise attached to the surface.

As previously mentioned, the integral casing 25 may also be operatively configured allow a substantial portion of each of the material sprayer 30 and the material dispenser 40 to be, for example, encased in said integral casing 25. This may be shown, for example, in FIG. 8.

The material sprayer 30 may be comprised of a spray pump mechanism 34 and a spray initiator 36. The spray pump mechanism 34 may be, for example, a manual pump or an automated pump which may be initiated by the spray initiator 36 of the material sprayer 30. Activating the spray initiator 36, may comprise operating a lever, a switch, a button, or electronic mechanism. This may be shown and illustrated, for example, in FIG. 9.

The spray initiator 36 may be, for example, a trigger or lever. The trigger or lever spray initiator 36 may be pulled in order to operate the spray pump mechanism 34. Upon activation of the spray initiator 36, the material sprayer 30 may expel a spray of cleansing material 52 as previously discussed. Further, the cleansing material 52 may exit the material sprayer 30 through the material sprayer nozzle 37, as shown in FIG. 7, FIG. 8, and FIG. 9.

As still another example, the spray initiator 36 may be, for example, a button. The button spray initiator 36 may be pushed in order to operate the spray pump mechanism 34. Upon activation of the spray initiator 36, the material sprayer 30 may expel a spray as previously discussed.

As still another example, in order to activate the spray pump mechanism 34, the spray initiator 36 may be an electronic mechanism. For example, the spray initiator 36 may be a key pad, a lock, an electronic key card station, a biometric data scanner, or a voice, motion, or pressure operated sensor. To initiate operating the spray pump mechanism 34, the user may, for example, enter the correct pin number into a key pad, unlock a lock, swipe an electronic key card, offer a biometric data sample, or activate a voice, motion, or pressure sensor. (For example, FIG. 4 illustrates the case in which the spray initiator 36 is a sensor. The sensor of FIG. 4 may be, for example, either a motion sensor or a pressure sensor. As an additional example, FIG. 6 may illustrate the case in which the spray initiator 36 is an electronic device, including, for example, a touchpad with numbers or letters, a voice sensor, a fingerprint or retinal scanner (biometric data collecting device), or an electronic card reader swiping mechanism.) It is also inherently included herein that combinations of one or more of the spray initiating activities previously mentioned may be incorporation as the spray initiator 36. It should be noted that any of aforementioned mechanisms that may prove difficult for the user to both operate the spray initiator and hold the object or material to be cleaned may be set up operate on a timer such that the user may be given the appropriate time to activate the spray initiator 36 and aim the material sprayer 30 at the object or material.

Once initiated, the spray pump mechanism 34 may bring cleansing material 52 from the container 51 to the material sprayer 30 to be expelled from the integral cleaner apparatus 11. That is, the cleansing material 52 may be contained in said container until such a dispense or spray activation occurs.

The spray of cleansing material 52 that may be sprayed from the material sprayer 30 may be, for example, a liquid jet, a mist, an atomized spray, an aerosol spray, or a nebulized spray. Once the cleansing material 52 has exited the integral cleaner apparatus 11, it may be referred to as expended cleaning material 52. The material sprayer 30 may be operatively associated with the container 51 such that the material sprayer 30 may communicate directly with the container 51.

In addition to the material sprayer 30, a material dispenser 40 may also be associated with the integral casing 25 of the integral cleaner apparatus 11 such that, for example, a substantial portion of the material dispenser may be encased in the integral casing 25. This may be shown, for example, in FIG. 7, FIG. 8, and FIG. 9. The material dispenser 40 may further comprise a dispense pump mechanism 44 and a dispense initiator 46. The dispense pump mechanism 44 may be, for example, and automated or manual pump. The dispense initiator 46 may be, for example, a trigger. Upon activation of the dispense initiator 46, the material dispenser 40 may dispense a portion of cleansing material 52. Further, the cleansing material 52 may exit the material dispenser 40 through the material dispenser nozzle 47, as shown in FIG. 7, FIG. 8, and FIG. 9.

In order to activate the dispense initiator 46, a user may operate a lever, a switch, or a button (as is shown in FIG. 9.). As another example, in order to activate the dispense initiator 46, a user may enter the correct pin number into a key pad, unlock a lock, swipe an electronic key card, offer a biometric data sample for reading by a biometric data collector, activate a voice activated sensor, move to activate a motion sensor, or stand or push on an area to activate a pressure activated sensor. (As is shown in FIG. 4 and FIG. 5, the dispense initiator 46 may be a motion sensor or a pressure sensor.) Also, after a certain time, a timer automated sensor may activate the dispense initiator 46. It is also noted herein that combinations of those dispense initiating activities previously mentioned may be included herein. Once the dispense initiator 46 has been activated, the cleansing material 52 may be dispensed from the material dispenser 40 with the aid of the dispense pump 44. The dispense pump may be a manual pump, as when a user pushes a manual button in, or the dispense pump 44 may be an automated pump, as may be activated when a user trips a motion or pressure sensor.

The integral casing 25 may also incorporate a container 51, wherein the container 51 may be removably attached to said integral casing 25. This may be depicted as in, for example, FIG. 7 or FIG. 9. The container 51 may be removably attached as by being inserted, for example, into the integral casing 25 such that the entire container 51 may be enclosed and secured therein. This may be shown, for example, in FIG. 8 or FIG. 9. Also, the container 51 may be removably attached by being only partially inserted such that at least a portion of the container extends beyond the casing 25. This may be shown, for example, in previously referenced FIG. 7.

Container 51 may be inserted into the top, bottom, or side portion of the integral casing 25. The container 51 may be of any shape, dimension, or material that may retain a cleansing material 52. For example, the container 51 may comprise bottle, or bag, configured to associate with said integral casing 25. The container 51 may, for example, have at least one rigid wall. Alternatively, the container 51 may, for example, have at least one flexible wall such that as material is dispensed from the container 51, the volume of the container likewise proportionally decreases. That is, the cleansing material 52 may be retained in, for example, the container 51 until a time in which the spray initiator 36, the dispense initiator 46, or both may be activated. This may be shown for example, in FIG. 9. The container 51 may be composed of, for example, plastic, vinyl, polymer, wood, metal, nylon, fabric, or combinations thereof, to facilitate the retention of the cleansing material 52.

The cleansing material 52 may come out of the material dispenser 40 in a liquid jet, a spurt, a squirt, a shot, an encapsulated portion, a burst, a liquid spray, or a dense mist. Further, the cleansing material 52 may be expelled from the material dispenser 40 as a low viscosity liquid, a high viscosity liquid, or plurality of small droplets of liquid. The cleansing material 52 may be composed of one or more of various materials within the cleaning, sterilizing, sanitizing, disinfecting, or decontaminating fields. Also, the cleansing material 52 may be a liquid of high or low viscosity. For example, the cleansing material 52 may be composed of one or more materials selected from the group consisting essentially of: alcohol, phenol, peracetic acid, hydrogen peroxide, chlorine compounds, iodophors (iodine complexed with solubizing agent), peroxygen compounds, quaternary ammonium compounds, and combinations thereof. Further, the cleansing material 52 may be a known sterilizing agent, germicide, anti-microbial agent, disinfectant, cleanser, any OSHA approved material for cleaning, decontaminating, disinfecting, or sterilizing, or combinations thereof. In operation, the cleansing material 52 may exit the material sprayer 30, the material dispenser 40, or both at the same time.

The integral cleaner apparatus 11 may also comprise a relevant information indicator 21, as is shown, for example, in FIG. 4. This may be located, for example, on the integral casing 25, or alternatively, on the container 51. The relevant information indicator 21 may provide written or pictorial instructions to a user, material safety data sheet information about the cleansing material 52 contained in and expelled therefrom, manufacturer contact information, et cetera, to aid and/or inform the user in operating the integral cleaner apparatus 11.

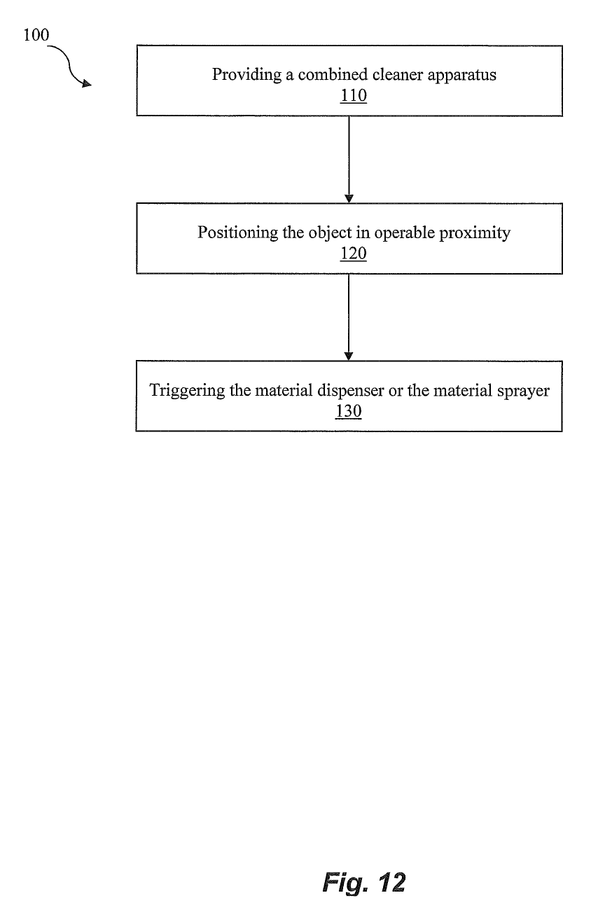

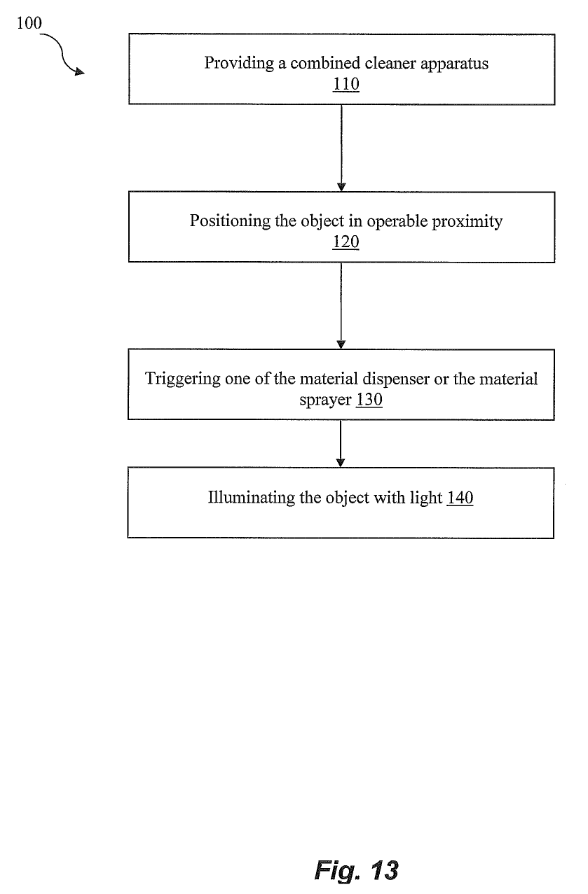

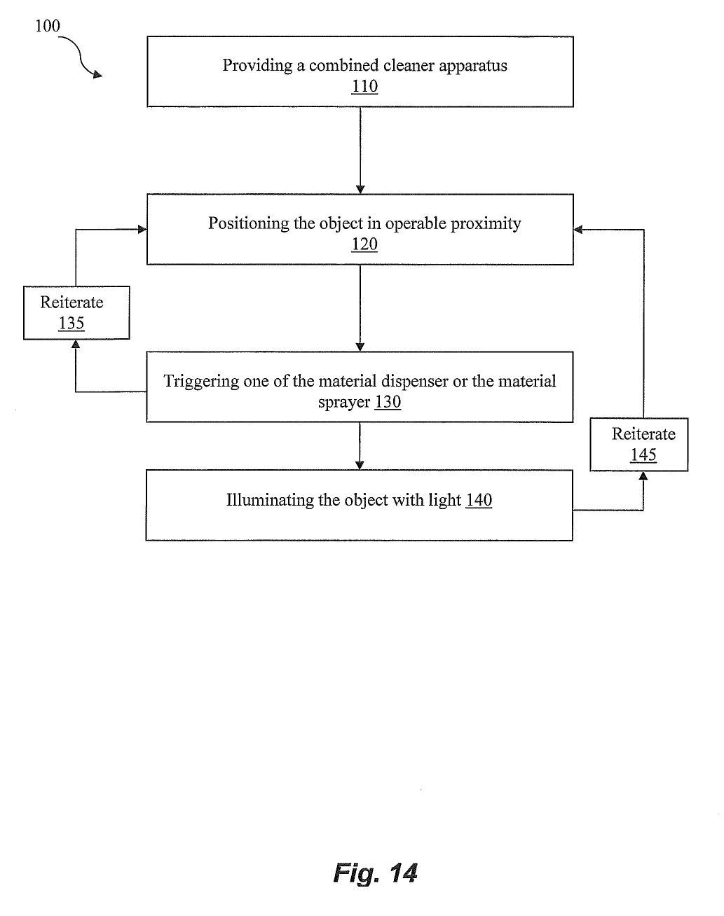

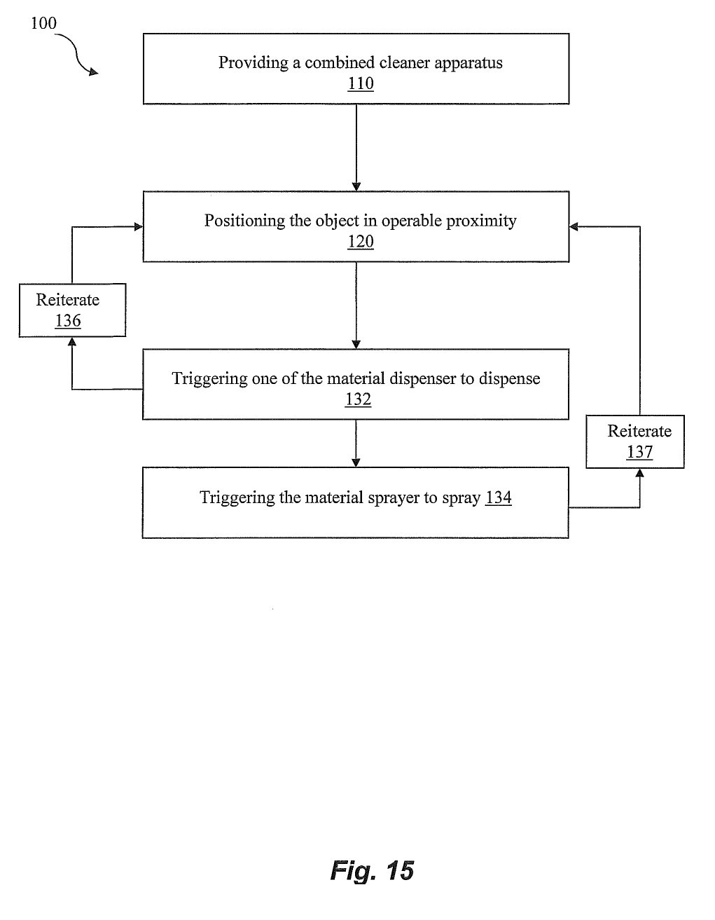

With continued reference to the drawings, a combined cleaner method 100 may comprise, for example, providing a combined tool and cleaner apparatus 110, positioning at least a portion of an object in operable proximity with said first housing element portion 120; and triggering at least one of said material dispenser and said material sprayer at least one time to expend the cleansing material onto at least a portion of said object 130. The combined cleaner method 100 may be depicted, for example, in the following figures, including FIG. 12, FIG. 13, FIG. 14, and FIG. 15.

As previously stated, the combined cleaner method 100 includes the step of providing a combined tool and object cleaner apparatus 110. The combined tool and object cleaner apparatus 110 may further include: a housing element, said housing element having a first housing element portion; a material sprayer and a material dispenser, wherein the material sprayer and the material dispenser are configured to associate to said first housing element portion; at least one material providing body, wherein the at least one of the material sprayer and the material dispenser is in communication with the at least one material providing body; a cleansing material, said cleansing material retained in said material providing body.

The housing element of the combined tool and object cleaner apparatus may be, for example, the casing 20 as disclosed in reference to the cleaner apparatus 10, or the integral casing 25 as disclosed in reference to the integral cleaner apparatus 11. The various embodiments of those casings may be shown and depicted, for example, in FIG. 1 through FIG. 9. Similarly, the material dispenser 40 and the material sprayer 30 may be in the form of the previous embodiments, discussed in reference to the cleaner apparatus 10 and the integral cleaner apparatus 11 and shown in FIG. 1 through FIG. 9. Further, the material providing body may be, for example, the material retaining member 50 (including a material feeder facilitator, fixed volume containers, or the remote feed tube), as shown and described with reference to the cleaner apparatus 10 (and likewise, FIG. 1 through FIG. 6). Alternatively, the material providing body may be a container 51, as disclosed in reference to the integral cleaner apparatus 11 and as shown and described in FIG. 7, FIG. 8, and FIG. 9. It should be noted that the cleansing material 52 may include, for example, any decontaminating, sterilizing, cleaning, or sanitizing material in solution, mixture, or pure form, or combinations thereof, which may be commonly accepted, known, or used for any or all of those purposes.

After providing a combined tool and cleaner apparatus 110, the combined cleaner method 100 may comprise, for example, positioning at least a portion of an object in operable proximity with said first housing element portion 120. This may be done, for example, by holding the object in place adjacent to or beneath the combined tool and cleaner apparatus 10, 11 such that the material dispenser 40, material sprayer 30, or UV light 70 may be operated in such a manner as to affect the object. For example, dispensing a predetermined or otherwise selectable amount of cleansing material 52 onto the surface of the object, or by irradiating ultraviolet light in a certain predetermined or preselected incident angle of radiation, at one or more wavelengths, for a period of illumination time are a few options of operation.

The operable proximity may be considered as the range of distance that an object may be positioned from the combined tool and object cleaner apparatus in order for one or more of the components (material dispenser 40, material sprayer 30, or UV light 70) to reach and operate on the object. Alternatively, the operable proximity may refer to an ideal displacement or distance that the object may be from one or more of the components (material sprayer 30, material dispenser 40, UV light 70) so that cleansing material 52 or UV radiation may be dispensed, expended, or disbursed onto the object in a preferable or ideal amount.

Also, although previously mentioned, it should be noted that the object referred to in reference to the combined cleaner method may include, for example, a medical tool, medical instrument, writing implement, writing aid, reading aid, article of clothing, accessory, or body part of a user, including one or more of the user's hands, arms, feet, areas of skin, or any other element, component, member, or part that a user may find need to cleanse, sanitize, decontaminate, or sterilize. For example, the object may further comprise a stethoscope, which may be cleaned between uses with the aid of the combined cleaner apparatus. This may be seen, for example, in FIG. 9, as referenced by the object 55. As another example, the object may be a user's body part. The user may be, for example, someone with purpose to be in a doctor's office or hospital, a consumer or customer of a store, patrons of a bathroom facility, etc. . . .

After positioning at least a portion of an object in operable proximity with said first housing element portion 120, the combined cleaner method 100 may comprise, for example, triggering at least one of said material dispenser and said material sprayer at least one time to expend the cleansing material onto at least a portion of said object 130. The combined cleaner apparatus 10, 11 may be triggered by triggering either of the material sprayer 30 or material dispenser 40.

Further, the action or step of triggering at least one of said material dispenser 40 and said material sprayer 30 further comprises one of the actions selected from the group consisting of: pushing a lever, pushing a button, entering a code into a key pad, unlocking a lock, swiping an electronic key card, providing a biometric sample to a biometric data collector, activating a motion sensor, activating a voice sensor, activating a pressure sensor, and combinations thereof. These triggering steps may refer to the steps as previously disclosed with reference to both the cleaner apparatus 10 and the integral cleaner apparatus 11, as described and shown in FIG. 1 through FIG. 9.

Alternatively, the step of triggering may comprise each of said material dispenser 40 and said material sprayer 30. That is, both the material sprayer 40 and the material dispenser 30 may be triggered either simultaneously or successively.

As previously mentioned, the combined cleaner method 100 may also further comprise the step of illuminating said object with ultraviolet light 140. That is, as disclosed with respect to the cleaner apparatus 10 and the integral cleaner apparatus 11, the combined cleaner apparatus may further comprise a UV light, such as UV light 70 as depicted in FIG. 6. The light may be used separately or in combination with one or more of the material sprayer 30 and material dispenser 40, in which the UV light 70 may illuminate a predetermined incident angle of UV radiation at a predetermined or preselected wavelength or wavelength range for one or more illumination cycles or periods of time. In such a manner, the step of illuminating an object with ultraviolet light 70 may further aid to the sanitization, sterilization, cleansing, and/or decontamination.

With reference to the combined cleaner method 100, it should be noted that one or more steps may be repeated or reiterated until the object may be treated to an acceptable level. Further, the combined cleaner method of the present invention may be performed on one or more objects in order to create desirable results.

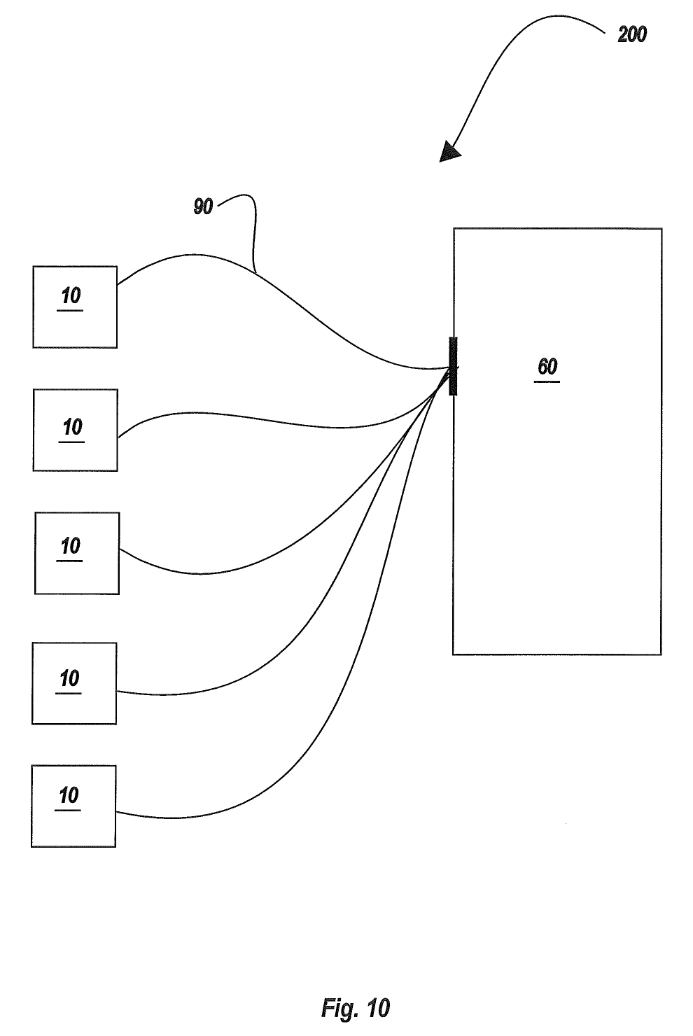

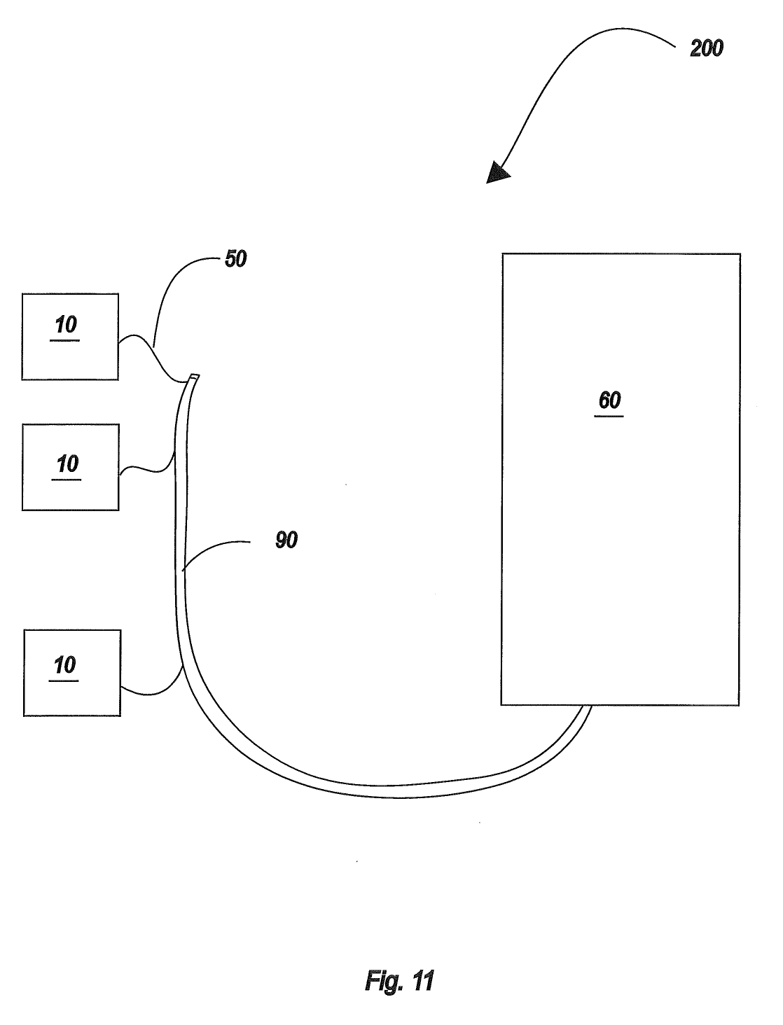

With continued reference to the drawings, a cleaner system 200 may comprise, for example: a plurality of cleaner apparatus', wherein each cleaner apparatus 10 includes: a casing 20; a material sprayer 30, movably engaged to said casing 20; a first casing portion 22 of said casing 20; a material dispenser 40 coupled to said first casing portion 22; a material retaining member 50, said material retaining member 50 housed in said casing 20, said material retaining member 50 coupled to at least one of said material sprayer 30 and said material dispenser 40; a remote material source 60; a cleansing material 52, said cleansing material 52 retained in said remote material source 60; and at least one material supply tube 54 for the plurality of cleaner apparatus', configured to associate each cleaner apparatus 10 to the remote material source 60. The cleaner system 200, in its various embodiments, may be shown and illustrated in FIG. 10 and FIG. 11.

As stated, the cleaner system 200 may comprise, for example: a plurality of cleaner apparatus' 10. Each cleaner apparatus 10 may further include: a casing 20; a material sprayer 40, movably engaged to said casing 20; a first casing portion 22 of said casing 20; a material dispenser 40 coupled to said first casing portion 22; and a material retaining member 50, said material retaining member 50 housed in said casing 20, said material retaining member 50 coupled to at least one of said material sprayer 30 and said material dispenser 40. Also, the cleaner system 200 may comprise a cleansing material 52, wherein said cleansing material 52 may be retained in said material retaining member 50. The material retaining member 50 may be, as previously disclosed, the remote feed tube 54. The remote feed tube 54 may link each cleaner apparatus 10 either directly to the remote material source 60 or to a material supply tube (shared central line) that may in turn communicate and link to the remote material source 60. The material retaining member 50, and likewise, the material supply tube (or shared central line), may be valved in order to prevent, for example, backflow of the cleansing material 52 into the remote material source 60. The cleansing material 52, as referred to herein, may likewise be of the same type and nature previously discussed with reference to the cleaner apparatus 10, the integral cleaner apparatus 11, and the combined cleaner method 100.

Further, the cleaner system 200 may comprise a remote material source 60. The remote material source 60 may supply the cleansing material 52 to the plurality of cleaner apparatus 10. The remote material source 60 may be kept in a secure location, with, for example, limited or restricted access. Also, the remote material source 60 may be kept at a location which may be easily accessed so that the cleansing material 52 supply may be replenished as needed. The remote material source 60 may be a large storage tank or container, and it may have one or more chambers. The remote material source 60 may be pressure and temperature stable, and/or the canister may be made of a shock resistant or robust material that will resist fissure, fracture, breakage, and leaking. That is, the remote material source 60 may be a secure containment facility. The remote material source 60 may be replaceable, as new units may be ordered and, when needed, attached in place of one or more old, spent remote material source 60 components.

As previously mentioned, the cleaner system 200 may also comprise at least one material supply tube 90 for each of the plurality of cleaner apparatus'. The material supply tube 90 may be configured to associate each cleaner apparatus 10 to the remote material source 60. The material supply tube 90 may communicate each cleaner apparatus 10 directly to the remote material source 60. That is, the number of material supply tube 90 may be equal to the number of cleaning apparatus 10. In such a manner, each of the material supply tubes 90 may individually feed cleansing material 52 directly to each cleaner apparatus 10, where it may then be stored, retained, or expended. This may be shown, for example, in FIG. 10.

Alternatively, the material supply tube 90 may be configured as one central line, which may feed from the remote material source 60 to each of the cleaner apparatus' 10, through the material feeder facilitator 50 of each. In such a configuration, the material feeder facilitator 50 of each cleaner apparatus 10 may be configured as a remote feed tube 54. That is, each of the cleaner apparatus 10 may be connected via its remote feed tube 54 to the material supply tube 90 which may feed cleansing material 52 to each of the plurality of cleaner apparatus 10 from the remote material source 60. In this configuration, the at least one material supply tube 90 may be essentially shared by the plurality of cleaner apparatus 10. This may be shown, for example, in FIG. 11.

Embodiments of the combined cleaner apparatus such as either the integral cleaning apparatus 11 or the cleaner apparatus 10 may be wall mounted outside of one or more inpatient and outpatient medical rooms in, for example, hospitals and private practices. Use of the combined cleaner apparatus in such a manner may, for example, increase the speed and convenience of cleaning medical instruments prior to a patient encounter. That is, using the combined cleaner apparatus (either the integral cleaning apparatus 11 or the cleaner apparatus 10) may decrease the risk of transmitting infectious pathogens like viruses and bacteria. Further, any of the embodiments of the present invention combine the functions of, for example, a hand sanitizer with a medical instrument cleaner.

In one practicable embodiment of the combined cleaner apparatus, such as either the integral cleaner apparatus 11 or the combined cleaner apparatus 10, the material dispenser 40 may dispense or deliver a cleansing material 52 in the form of, for example, hand sanitizing solution, via a dispense pump mechanism 44. The hand sanitizing solution may be contained in a material retaining body 50 such as, for example, a reservoir or container 51, which may be housed either wholly or partially within the combined cleaner apparatus' casing 20 or integral casing 25. The cleansing material 52 may be, for example, a 70% isopropyl alcohol solution or other cleaning, sanitizing, sterilizing, decontaminating agent or ingredient. Further, the combined cleaner apparatus may be configured in dimensions such that a material sprayer 30 may sit thereon or partially therein the casing 20 or integral casing 25 of the combined cleaner apparatus. The material sprayer 30 may also be configured to attach/detach from the casing 20 or integral casing 25 of the combined cleaner apparatus. In such a manner, the material sprayer 30 may have a spray pump initiator 36 which may be in the form of a trigger. Also, the material sprayer 30 may include a spray pump mechanism 34, to communicate cleansing material 52 from the material retaining member 50 or container 51 to the material sprayer 30 and out of the spray nozzle 37, when, for example, the trigger may be pressed. It should be noted that when the material sprayer 30 may be in a detached position from the combined cleaner apparatus 10,11, the material sprayer 30 (and spray pump mechanism 34) may communicate to the container 51 or material retaining member 50 via a retractable tubing 32.

The retractable tubing 32 may allow the material sprayer 30 to be moved away from the combined cleaner apparatus 10, 11 and positioned in one or more desirable positions/locations which may be ideal for the accurate and precise aim and spraying cleansing material 52. In such a manner, a user may adjust the height, angle, direction, and displacement of the spray from an object. The material sprayer 30 may, for example, spray to cover a wider surface area than the material dispenser 40. Also, the material sprayer 30 may leave the object with a lighter covering or less overall cleansing material 52 thereon such that the coating of cleansing material 52 on the object may dry in a quick and efficient manner.

Also, various embodiments, the cleansing material 52 in the material dispenser 30 and the cleansing material 52 in the material sprayer 40 may be the same material and dispensed from the same material retaining member 50 or container 51, or different materials dispensed from different containers 51. In the prior arrangement, the 70% isopropyl alcohol or other cleansing material 52 may be contained in, for example, a container 51 that may in turn be configured to associate with or otherwise connect to both the spray nozzle 37 and/or tubing 32 of the material sprayer 30 and a dispense pump mechanism 44 or the dispense nozzle 47 of a material dispenser 40. It should also be noted that the material retaining member 50 or container 51 of the combined cleaner apparatus 10, 11 may be a removable or replaceable member, such as a replaceable pre-loaded container or replaceable pre-loaded material retaining member. The replaceable members may be may be refillable (replace the cleansing material when low or empty) or recyclable/disposable (replace an entire material retaining member 50 or container 51 with a new member 50 or container 51). In operation, the material dispenser 40 and material sprayer 30 may be operated either one at a time or simultaneously.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

I claim:

1. A cleaner apparatus, comprising:
a casing;
a material sprayer, movably engaged to said casing;
a first casing portion of said casing;
a material dispenser coupled to said first casing portion; and
a material retaining member, said member removably attached to said casing, said material retaining member removably attached to said material sprayer and said material dispenser.

2. The cleaner apparatus of claim 1, further comprising a cleansing material, said cleansing material retained in said material retaining member.

3. The cleaner apparatus of claim 1, wherein the material sprayer further comprises a retractable tubing, said retractable tubing configured to couple said material sprayer to said material retaining member.

4. The cleaner apparatus of claim 1, wherein the material retaining member comprises at least one container, configured to associate with said casing.

5. The cleaner apparatus of claim 1, wherein the material retaining member comprises at least one tube configured to couple a material source to said cleaner apparatus.

6. The cleaner apparatus of claim 1, further comprising an ultraviolet light, wherein said ultraviolet light is configured to possibly associate to said casing.

7. The cleaner apparatus of claim 1, wherein the cleansing material is selected from one of the group consisting of: a cleanser, a sterilizer, a disinfectant, a decontaminant, and combinations thereof.

8. The cleaner apparatus of claim 1, wherein the casing further comprises a second casing portion configured to associate with the material dispenser to catch an expended cleansing material.

9. An integral cleaner apparatus, comprising:
an integral casing;
a material sprayer and a material dispenser, wherein a substantial portion of each of the material sprayer and the material dispenser are encased in said integral casing; and
at least one container, a portion of said container is encased by said integral casing wherein each of the material dispenser and the material sprayer is configured to associate to said container.

10. The integral cleaner apparatus of claim 9, further comprising a cleansing material, said cleansing material contained in said container.

11. The integral cleaner apparatus of claim 9, wherein the integral casing further comprises a surface mounter.

12. The integral cleaner apparatus of claim 9, wherein the material sprayer comprises a spray pump mechanism and a spray initiator.

13. The integral cleaner apparatus of claim 9, wherein the material dispenser comprises a dispense pump mechanism and a dispense initiator.

14. A combined cleaner method, comprising the steps of:
providing a combined tool and object cleaner apparatus, said combined apparatus including:
a housing element, said housing element having a first housing element portion;
a material sprayer and a material dispenser, wherein the material sprayer and the material dispenser are fixedly associated to said first housing element portion;
at least one material providing body, wherein the at least one of the material sprayer and the material dispenser is in communication with the at least one material providing body;
a cleansing material, said cleansing material retained in said material providing body;
positioning at least a portion of an object in operable proximity with said first housing element portion; and
triggering at least one of said material dispenser and said material sprayer at least one time to expend the cleansing material onto at least a portion of said object.

15. The method of claim 14, wherein the step of triggering at least one of said material dispenser and said material sprayer further comprises triggering each of said material dispenser and said material sprayer.

16. The method of claim 14, further comprising illuminating said object with ultraviolet light.

17. The method of claim 14, wherein the object further comprises a medical instrument.

18. The method of claim 14, wherein the object further comprises a user's body part.

19. The method of claim 12, wherein the step of triggering at least one of said material dispenser and said material sprayer further comprises one of the actions selected from the group consisting of:
pushing a lever, pushing a button, entering a code into a key pad, unlocking a lock, swiping en electronic key card, providing a biometric sample to a biometric data collector, activating a motion sensor, activating a voice sensor, activating a pressure sensor, and combinations thereof.

20. A cleaner system, comprising:
a plurality of cleaner apparatus', wherein each cleaner apparatus includes:
a casing;
a material sprayer, movably engaged to said casing;
a first casing portion of said casing;
a material dispenser coupled to said first casing portion;
a material retaining member, said material retaining member housed in said casing, said material retaining member coupled to at least one of said material sprayer and said material dispenser;
a remote material source;
a cleansing material, said cleansing material retained in said remote material source; and
at least one material supply tube for the plurality of cleaner apparatus', configured to associate each cleaner apparatus to the remote material source.

21. The cleaner system of claim 20, wherein the at least one material supply tube is shared by the plurality of cleaner apparatus'.

22. The cleaner system of claim 20, wherein the remote material source is a secure containment facility.
